(19) United States
(12) Patent Application Publication
(10) Pub. No.: US 2024/0425386 A1
(43) Pub. Date: Dec. 26, 2024

(54) REFRIGERATOR APPLIANCE AND WATER FILTER ASSEMBLY

(71) Applicant: Haier US Appliance Solutions, Inc., Wilmington, DE (US)

(72) Inventors: Bradford Gasior, Louisville, KY (US); Gregory Sergeevich Chernov, Louisville, KY (US)

(21) Appl. No.: 18/339,518

(22) Filed: Jun. 22, 2023

(51) Int. Cl. C02F 1/00; F25D 23/00

(52) U.S. Cl. CPC C02F 1/003; F25D 23/00; C02F 2201/006; F25D 2323/121

(57) ABSTRACT

A refrigerator appliance or water filtration assembly may include a filtration housing, a fluid inlet port, a fluid outlet port, a first electrical contact, a housing label, and an electrical connector. The fluid inlet port and the fluid outlet port may be fixed to the filtration housing. The first electrical contact may be positioned on the filtration housing separate and spaced apart from the fluid inlet port and the fluid outlet port. The housing label may be disposed on the filtration housing apart from the fluid inlet port and the fluid outlet port. The electrical connector may be joined to the housing label. The electrical connector may define an intermediate electrical path extending from the first electrical contact to conduct power or communication signals between the water filtration assembly and a separate appliance.

### FIELD OF THE INVENTION

The present subject matter relates generally to refrigerator appliances, and more particularly to a power or communication delivery configuration for a water filtration assembly of a refrigerator appliance.

### BACKGROUND OF THE INVENTION

Refrigerator appliances generally include a cabinet that defines a chilled chamber. A wide variety of food items may be stored within the chilled chamber. The low temperature of the chilled chamber relative to ambient atmosphere assists with increasing a shelf life of the food items stored within the chilled chamber. Refrigerator appliances may also be equipped with a dispensing system. Such dispensing systems typically provide chilled water and/or ice from inside of the refrigerator appliance to a dispensing outlet accessible from inside or outside of the refrigerator appliance.

Certain refrigerator appliances further include water filter assemblies for filtering water. Water filter assemblies can filter water entering the refrigerator appliances to provide filtered water to various refrigerator appliance components, such as an ice maker and/or a water dispenser of the aforementioned dispensing system. Such filtering can improve a taste and/or an appearance of water within the refrigerator appliances.

The water filter assemblies may include one or more features that require power, such as various lights, sensors, valves, actuators, filtration means, hardware, etc. Conventionally, the water is routed in and out of the filter assembly through a filter manifold, which is generally a permanent component of the refrigerator appliance. As such, the power is typically transferred or supplied to the internal electronic components of the water filter assemblies via integration of electrical connections into the manifold. However, power through the manifold can increase the risk of water exposure to the electronic components of the filter assembly. In addition, routing the power through the manifold can also increase the complexity of the design of the manifold.

Other filtration assemblies may thus use wireless electrical components. However, wireless technology can increase the costs of the overall appliance as well as the water filtration assembly, which in certain circumstances, may be undesirable.

In view of the aforementioned, the present disclosure is directed to a unique power and/or communication delivery configuration for a water filtration assembly of a refrigerator appliance.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a water filtration assembly is provided. The water filtration assembly may include a filtration housing, a fluid inlet port, a fluid outlet port, a first electrical contact, a housing label, and an electrical connector. The fluid inlet port and the fluid outlet port may be fixed to the filtration housing. The first electrical contact may be positioned on the filtration housing separate and spaced apart from the fluid inlet port and the fluid outlet port. The housing label may be disposed on the filtration housing apart from the fluid inlet port and the fluid outlet port. The electrical connector may be joined to the housing label. The electrical connector may define an intermediate electrical path extending from the first electrical contact to conduct power or communication signals between the water filtration assembly and a separate appliance.

In another exemplary aspect of the present disclosure, a refrigerator appliance is provided. The refrigerator appliance may include a cabinet and a water filter mounted to the cabinet. The cabinet may define a chilled chamber. The water filter may include a filtration housing, a fluid inlet port, a fluid outlet port, a first electrical contact, a housing label, and an electrical connector. The fluid inlet port and the fluid outlet port may be fixed to the filtration housing. The first electrical contact may be positioned on the filtration housing separate and spaced apart from the fluid inlet port and the fluid outlet port. The housing label may be disposed on the filtration housing apart from the fluid inlet port. The electrical connector may be joined to the housing label. The electrical connector may define an intermediate electrical path extending from the first electrical contact to conduct power or communication signals between the water filter and the cabinet. The refrigerator appliance may also include a second electrical contact fixed to the cabinet and spaced apart from the filtration housing in selective electrical communication with the first electrical contact.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides an elevation view of a refrigerator appliance according to exemplary embodiments of the present disclosure.

FIG. 2 provides a perspective view of the exemplary refrigerator appliance of FIG. 1.

FIG. 3 provides an elevation view of the exemplary refrigerator appliance of FIG. 1, wherein the doors are shown in an open position.

FIG. 4 provides a simplified side elevation view of an embodiment of a water filtration assembly within a refrigerator appliance according to exemplary embodiments of the present disclosure.

FIG. 5 provides a perspective view of a water filtration assembly, including an illustration of a second electrical contact sub-assembly separated from the rest of the water filtration assembly for clarity.

FIG. 6 provides an exploded perspective view of the exemplary water filtration assembly of FIG. 5.

FIG. 7A provides a side perspective view of the water filter of the exemplary water filtration assembly of FIG. 5.

FIG. 7B provides a cross-sectional perspective view of the water filter of the exemplary water filtration assembly of FIG. 5.

FIG. 7C provides an exploded perspective view of the water filter of the exemplary water filtration assembly of FIG. 5.

FIG. 8 provides a cross-sectional perspective view of the housing cap of the exemplary water filtration assembly of FIG. 5.

FIG. 9 provides a cross-sectional perspective view of a portion of the filter label of the exemplary water filtration assembly of FIG. 5.

FIG. 10 provides a perspective view of a portion of the housing cap of the exemplary water filtration assembly of FIG. 5

FIG. 11 provides a simplified side perspective view of an embodiment of a water filtration assembly within a refrigerator appliance according to exemplary embodiments of the present disclosure.

FIG. 12 provides an exploded perspective view of the water filter of the exemplary water filtration assembly of FIG. 11.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods for wired power or communication delivery for a replaceable element, such as a water filtration assembly, of an appliance, such as a refrigerator appliance. In particular, in certain embodiments, the water filtration assembly of the present disclosure generally includes a filtration housing suitable for mounting to a wall of the appliance via a manifold. A housing label may be stuck onto the filtration, such by adhesive. An electrical connector may be provided with or within the housing level to facilitate an electrical connection between the appliance and one or more electronic components within the filtration housing.

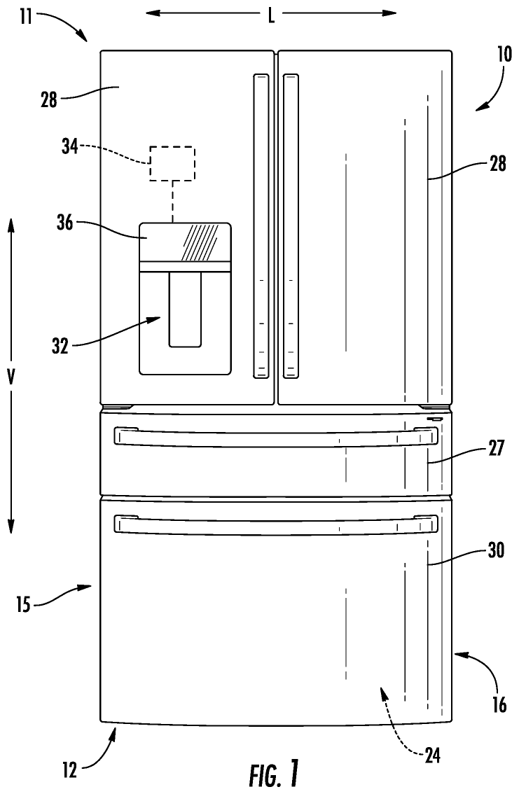

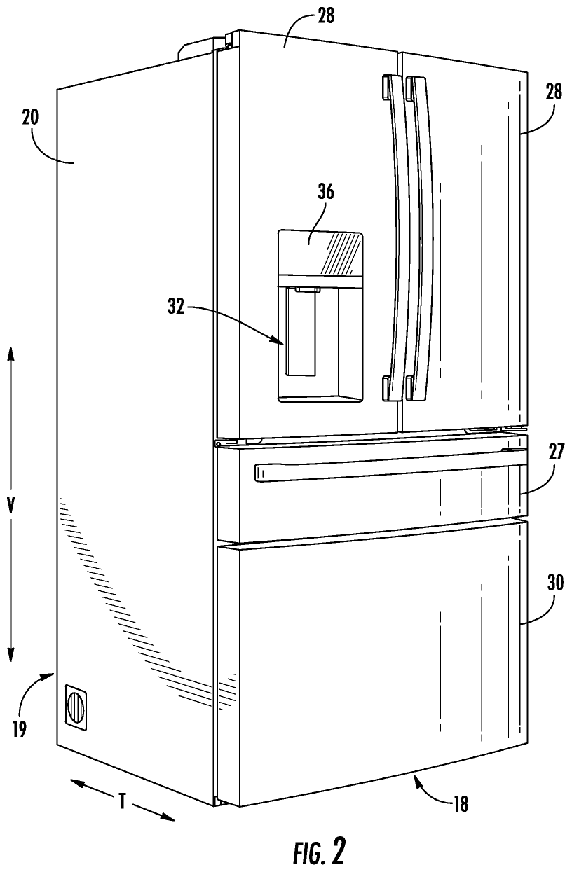

Referring now to the drawings, FIG. 1 illustrates a front view of an embodiment of a refrigerator appliance 10 according to the present disclosure. FIG. 2 illustrates a perspective view of the refrigerator appliance 10 of FIG. 1. FIG. 3 illustrates a front view of the refrigerator appliance 10 of FIG. 1 with refrigerator doors 28 in an open position. Referring particularly to FIG. 1, the refrigerator appliance 10 extends between a top 11 and a bottom 12 along a vertical direction V. The refrigerator appliance 10 also extends between a first side 15 and a second side 16 along a lateral direction L. As shown in FIG. 2, a transverse direction T may additionally be defined perpendicular to the vertical and lateral directions V. L. The refrigerator appliance 10 extends along the transverse direction T between a front portion 18 and a back portion 19.

The refrigerator appliance 10 may include a cabinet or housing 20 (FIG. 2) defining an upper fresh food chamber 22 (FIG. 3) and a lower freezer storage chamber 24 arranged below the upper fresh food chamber 22 along the vertical direction V. An auxiliary food storage chamber may be positioned between the upper fresh food chamber 22 and the lower freezer storage chamber 24, e.g., along the vertical direction V. Because the lower freezer storage chamber 24 is positioned below the upper fresh food chamber 22, the refrigerator appliance 10 may be generally referred to as a bottom mount refrigerator. In the embodiment, the housing 20 may also define a mechanical compartment (not shown) for receipt of a sealed cooling system (not shown). Using the teachings disclosed herein, one of ordinary skill in the art will understand that the present technology can be used with other types of refrigerators (e.g., side-by-side) or a freezer appliance as well. Consequently, the description set forth herein is for illustrative purposes only and is not intended to limit the technology in any aspect.

Referring now particularly to FIG. 3, the refrigerator doors 28 may each be rotatably hinged to an edge of the housing 20 for accessing the upper fresh food chamber 22. It should be noted that while two refrigerator doors 28 in a “French door” configuration are illustrated, any suitable arrangement of doors utilizing one, two or more doors is within the scope and spirit of the present disclosure. A freezer door 30 may be arranged below the refrigerator doors 28 for accessing the lower freezer storage chamber 24. In the embodiment, the freezer door 30 is coupled to a freezer drawer (not shown) slidably mounted within the lower freezer storage chamber 24. An auxiliary door 27 may be coupled to an auxiliary drawer which may be slidably mounted within the auxiliary chamber.

Referring back to FIG. 1, operation of the refrigerator appliance 10 can be regulated by a controller 34 that is operatively coupled to a user interface panel 36. The user interface panel 36 may provide selections for user manipulation of the operation of the refrigerator appliance 10 to modify environmental conditions therein, such as temperature selections, etc. In some embodiments, the user interface panel 36 is proximate a dispenser assembly 32. In response to user manipulation of the user interface panel 36, the controller 34 may operate various components of the refrigerator appliance 10. Operation of the refrigerator appliance 10 may be regulated by the controller 34, e.g., the controller 34 may regulate operation of various components of the refrigerator appliance 10 in response to programming and/or user manipulation of the user interface panel 36.

The controller 34 may include a memory and one or more microprocessors, CPUs or the like, such as general or special purpose microprocessors operable to execute programming instructions or micro-control code associated with operation of the refrigerator appliance 10. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller(s) 34 as disclosed herein are capable of and may be operable to perform any methods and associated method steps as disclosed herein.

The controller 34 may be positioned in a variety of locations throughout the refrigerator appliance 10. In the illustrated embodiment, the controller 34 is located within the refrigerator doors 28. In such an embodiment, input/output (“I/O”) signals may be routed between the controller and various operational components of the refrigerator appliance 10. In one embodiment, the user interface panel 36 represents a general purpose I/O (“GPIO”) device or functional block. In one embodiment, the user interface panel 36 includes input components, such as one or more of a variety of electrical, mechanical or electro-mechanical input devices including rotary dials, push buttons, and touch pads. The user interface panel 36 may include a display component, such as a digital or analog display device designed to provide operational feedback to a user. For example, the user interface panel 36 may include a touchscreen providing both input and display functionality. The user interface panel 36 may be in communication with the controller via one or more signal lines or shared communication busses.

Using the teachings disclosed herein, one of skill in the art will understand that the present disclosure can be used with other types of refrigerators such as a refrigerator/freezer combination, side-by-side, bottom mount, compact, and any other style or model of refrigerator appliance. Accordingly, other configurations of the refrigerator appliance 10 could be provided, it being understood that the configurations shown in the accompanying figures and the description set forth herein are by way of example for illustrative purposes only.

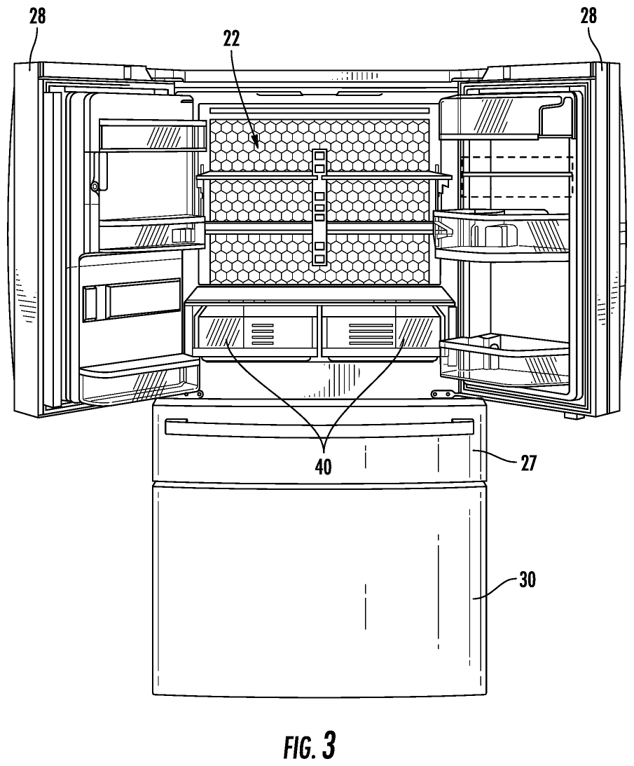

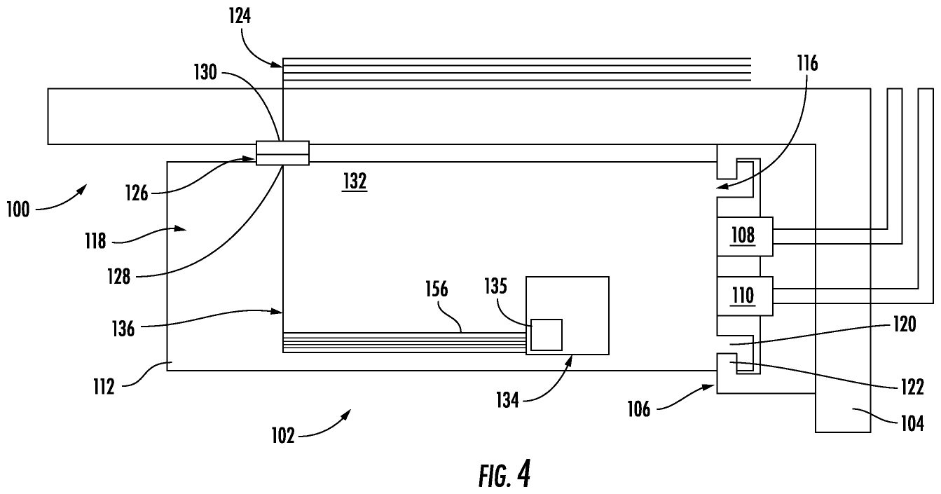

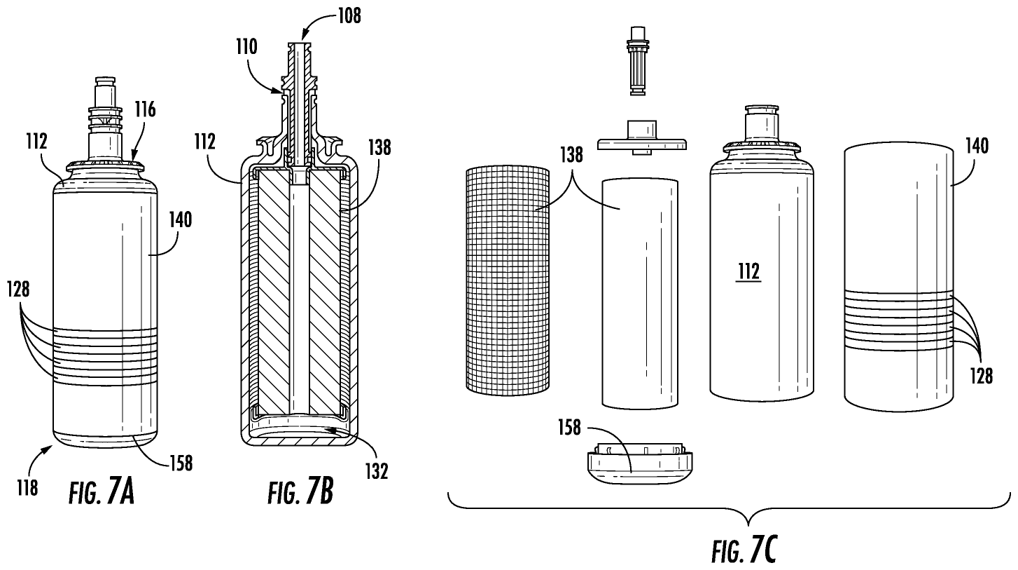

Referring now to FIG. 4, a simplified side view of an embodiment of an appliance wall 104 of an appliance 100 (such as an interior wall, an exterior wall, a side wall, etc.) having a water filtration assembly 102 secured thereto is illustrated. In particular, as shown, the water filtration assembly 102 has a filtration housing 112. As would be understood, a volume or mass of filtration media (e.g., water filtration cartridge 138-FIGS. 7B and 7C) may be disposed within filtration. Optionally, the filtration housing 112 may have a cylindrical configuration. In further embodiments, the filtration housing 112 may have any other suitable configuration other than a cylindrical configuration. Moreover, as shown, the water filtration assembly 102 may also include a liquid receiving space 132 within the filtration housing 112 and an electronics compartment 134 having one or more electronic components 135 (e.g., various lights, sensors, valves, actuators, filtration means, etc., as would be understood) housed, at least in part, therein. In such embodiments, the electronics compartment 134 is fluidly isolated from the liquid receiving space 132, and thus fluidly isolated from the flow of water received within the liquid receiving space 132.

In further embodiments, as shown, the water filtration assembly 102 includes a manifold 106 that can be mounted to the appliance wall 104 of the appliance 100. Accordingly, as shown, the manifold 106 may generally contain a filter latching/mating interface and water connections therein.

Generally, and as would be understood, the appliance 100 includes a water source (not shown) that provides water to and from the water filtration assembly 102 (e.g., through the manifold 106 via a water inlet 108 and a water outlet 110). Thus, in certain embodiments, the water filtration assembly 102 is in fluid communication with the water inlet 108 and the water outlet 110. It is noted that although FIG. 4 illustrates a simplified view whereby the water inlet 108 and water outlet 110 are spaced apart (e.g., at the same end of filtration housing 112), alternative embodiments may provide a coaxial inlet-outlet configuration, or other suitable configuration for a separate inlet and outlet for a filtration assembly, as would be understood.

The filtration housing 112 includes a first end 116 opposite a second end 118. In optional embodiments, the first end 116 includes one or more features for securing the water filtration assembly 102 to the manifold via the filter latching/mating interface, with the manifold 106 being secured to the appliance wall 104 of the appliance 100. For instance, the filter latching/mating interface may include the first end 116 of the filtration housing 112 having one or more interlocking features 120 and corresponding interlocking features 122 of the manifold 106. In some such embodiments, the interlocking features 120 of the first end 116 of the filtration housing 112 are configured to engage with the corresponding interlocking features 122 of the manifold 106 for securing the filtration housing 112 to the appliance 100. In further embodiments, the first end 116 of the filtration housing 112 may be secured to the manifold 106 using any other suitable means.

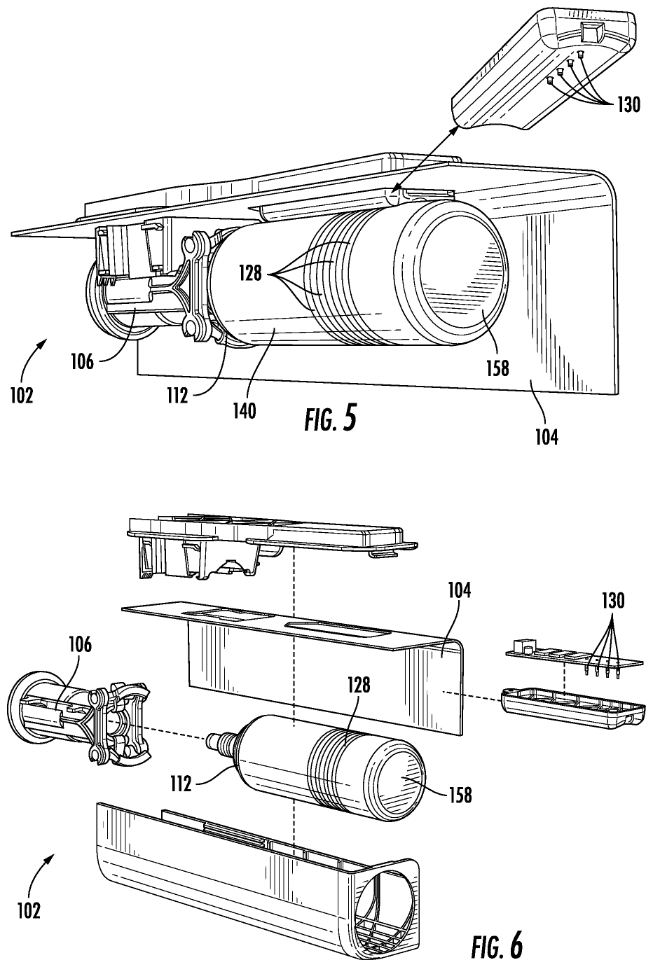

Referring still to FIG. 4, the water filtration assembly 102 further includes an electrical connection 126 electrically coupling the water filtration assembly 102 to a power source or a controller (e.g., controller 34-FIG. 1). Generally, the power source may be any suitable source of electricity. More specifically, as shown, the electrical connection 126 may include at least one first electrical contact 128 positioned on the filtration housing 112 and at least one second electrical contact 130 fixed to the cabinet 20 (e.g., positioned on the appliance wall 104 of the appliance 100). When installed or mounted to the appliance 100 (FIG. 4), the first electrical contact(s) 128 is configured to align with the second electrical contact(s) 130, details of which are further explained herein below with respect to FIGS. 5 through 12.

Generally, the electrical connection 126 may include one or more electrical harnesses 136, 124. For instance, a first electrical harness 136 includes various electrical paths (e.g., connected in series or parallel) and is configured to electrically couple the first electrical contact 128 to an electronics compartment 134 (FIG. 4) having one or more electronic components 135 (FIG. 4) housed within the filtration housing 112. Moreover, as shown, a second electrical harness 124 is configured to electrically couple the second electrical contact 130 to the power source or any other communication device, such as a controller 34 (FIG. 1).

Generally, the electrical connection 126 is separate and spaced apart from the manifold 106 and the flow of water received therein, e.g., separate and spaced apart from the water inlet port(s) 108 and the water outlet port(s) 110. As such, in an embodiment, when the first electrical contact(s) 128 contacts the second electrical contact(s) 130, power is provided to the water filtration assembly 102 from the power source, for example, via the electrical connection 126. In addition to providing power or in the alternative, one or more other signals for communication, security, or sensing may also be provided to the water filtration assembly 102 when the first electrical contact(s) 128 contacts the second electrical contact(s) 130.

Turning now generally to FIGS. 5 through 12, a housing label 140 may be disposed on the filtration housing 112. Generally, the housing label 140 is separate and spaced apart from the fluid inlet port 108 and the fluid outlet port 110. For instance, the housing label 140 may include an adhesive layer or coating (e.g., applied to an interior surface of the housing label 140) that adheres or sticks to an external surface of filtration housing 112. Additionally or alternatively, a separate exterior label or coating (e.g., fitted polymer, such as a shrink wrap or vacuum-sealed layer) may be provided to hold housing label 140 to filtration housing 112. Optionally, housing label 140 may extend about at least a portion of filtration housing 112. As would be understood, housing label 140 may include printed text, labeling, or figures indicative or descriptive of the water filtration assembly 102. Nonetheless, as would also be understood, the present disclosure is not limited to any particular printed text, labeling, or figures.

In some embodiments, an electrical connector (e.g., electrical passthrough facilitating an electrical current to flow therethrough) 142 is provided on, with, beneath, or through the housing label 140. Generally, the electrical connector 142 defines an intermediate electrical path 154 (e.g., singular path or, alternatively, plurality of electrically parallel paths) that extends outside (e.g., partially or, alternatively, fully outside) of at least a portion of the filtration housing 112. When assembled (e.g., such that filtration housing 112 is mounted within appliance in fluid connection with a water source), intermediate path may conduct power or communication signals between the water filtration assembly 102 and the separate appliance 100 (FIG. 4).

As shown, electrical connector 142 may extend from a first connector end 144 to a second connector end 146. Generally, between the first connector end 144 and the second connector end 146 one or more circuit conductors (e.g., wires, conductive traces, pins, etc.) through which a current may be conducted between first connector end 144 and second connector end 146. In some embodiments, electrical connector 142 is joined to the housing label 140, such as between first connector end 144 and second connector end 146 (e.g., by an adhesive, attachment panel, embedding material, or other suitable conductor attachment structure, as would be understood). Optionally, both first connector end 144 and second connector end 146 (e.g., the entirety of electrical connector 142 between first connector end 144 and second connector end 146) may be disposed outside of the liquid receiving space 132, electronics compartment 134 (FIG. 4), or general interior of filtration housing 112.

In certain embodiments, first connector end 144 is defined as or at first electrical contact 128. Thus, the intermediate electrical path 154 may extend from the first electrical contact 128 to conduct power or communication signals between the water filtration assembly 102 and the separate appliance 100 (FIG. 4). In embodiments wherein multiple discrete contacts 128 are provided, a similar number of branches of intermediate electrical path 124 may be provided (e.g., in parallel to each other). In additional or alternative embodiments, second connector end 146 is defined as or at one or more housing contact pads 148. The contacts pads 148 may correspond (e.g., in number and placement) to the (e.g., parallel) electrical branches of path 154 or, alternatively, be distinct (e.g., in number and placement) from the (e.g., parallel) electrical branches of path 154 while still being in electrical communication with the same (e.g., directly or, alternatively, indirectly, such as through an electrical chip 170). Additionally or alternatively, the contact pad(s) 148 may be disposed on or fixed to the external surface of filtration housing 112. Optionally, the housing contact pads 148 may be disposed beneath or on an internal surface of housing label 140. When assembled the intermediate electrical path 154 may extend to the housing contact pad(s) 148 to conduct power or communication signals between the water filtration assembly 102 and the separate appliance 100 (FIG. 4).

Turning especially to FIGS. 5 through 10, the first electrical contact(s) 128 may include axially spaced pads. In particular, first electrical contact(s) 128 may be formed or be shaped as one more conductive rings. For instance, first electrical contact 128 may extend around at least a portion of filtration housing 112. Optionally, a plurality of first electrical contacts 128 may be provided as conductive rings. In particular, as shown, the water filtration assembly 102 may include a plurality of first electrical contacts 128 extending around at least a portion of the filtration housing 112. Optionally, a plurality of second electrical contacts 130 may be arranged on the appliance wall 104 of the appliance 100 (FIG. 4). Additionally or alternatively, each of the plurality of first electrical contacts 128 may generally have a ring-shaped configuration extending around an entire circumference of filtration housing 112. Accordingly, the ring-shaped first electrical contact(s) 128 allow for the filtration housing 112 to be installed in any orientation such that, regardless of the orientation, the first electrical contact(s) 128 align with the second electrical contact(s) 130. In such embodiments, the ring-shaped first electrical contacts 128 may be arranged adjacent to each other and may be axially spaced apart from each other (e.g., equally spaced or separated by differing distances along the axis of the filtration housing 112). In the illustrated embodiment, four first electrical contacts 128 are provided, however, it should be understood that more than four or less than four first electrical contacts 128 may be employed in the water filtration assembly 102 of the present disclosure.

Moreover, as shown, each of the plurality of second electrical contacts 130 is arranged on the appliance wall 104 of the appliance 100 (FIG. 4) to align with and contact one of the plurality of first electrical contacts 128 when the water filtration assembly 102 is mounted within the appliance 100. In some embodiments, the second electrical contacts 130 include or are provided spring-loaded contact pins, such as pogo pins (e.g., as shown), biased outward or downward toward first electrical contacts 128. Thus, as shown in the illustrated embodiment, four second electrical contacts 130 are provided, however, it should be understood that more than four or less than four second electrical contacts 130 may be employed in the water filtration assembly 102 of the present disclosure, with the number of second electrical contacts 130 corresponding to the number of first electrical contacts 128.

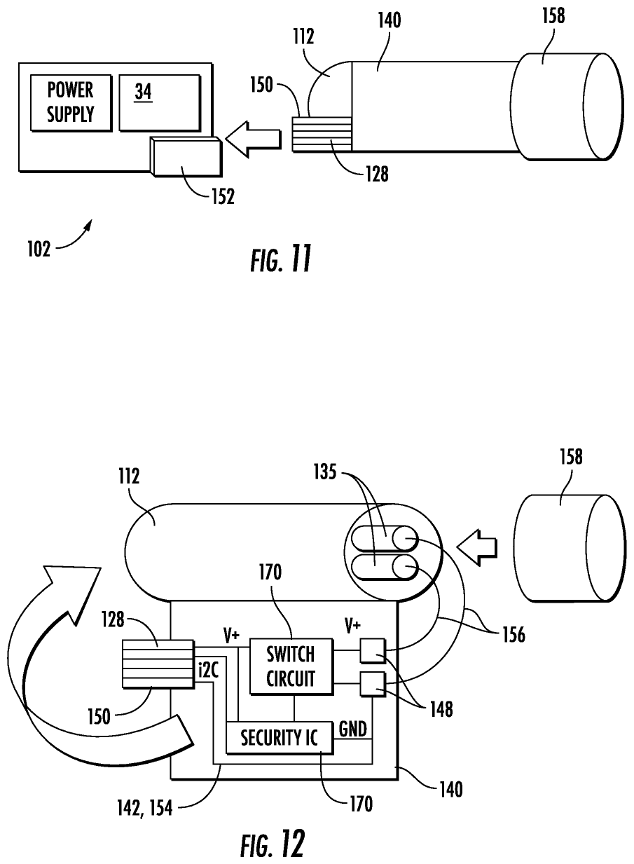

Turning briefly to FIGS. 11 and 12, although certain embodiments may include one or more conducive rings at the first electrical contacts 128, alternative embodiments may include a rigid card plug 150 (e.g., provided at or as part of the first electrical contact 128). Such a rigid card plug 150 may include, for instance, an edge connector having a printed circuit board including conductive traces or pathways leading to the edge of the board that are intended to plug into a matching contact socket 152. As shown, the rigid card plug 150 may extend outward from the housing label 140 (e.g., to the intermediate electrical path below the housing label 140).

The contact socket 152 may be fixed or mounted on the separate appliance 100 (FIG. 4), such as a female card socket to receive the rigid card plug 150. Moreover, the contact socket 152 may be in electrical communication with the power source or controller 34 (e.g., to direct power or communication signals between the appliance 100 (FIG. 4) and the water filtration assembly 102).

Returning generally to FIGS. 5 through 12, within the filtration housing 112, an internal electrical path 156 may be disposed in electrical communication with the intermediate electrical path 154. Specifically the internal electrical path 156 may connect the intermediate electrical path 154 to the one or more electronics components 135 (FIG. 4) provided within the filtration housing 112 (e.g., within the electronics compartment 134-FIG. 4). For instance, as noted above, one or more housing contact pads 148 may be provided (e.g., fixed on an external surface of) the filtration housing 112 to connect to the internal electrical path 156. In turn, the housing contact pads 148 may be in electrical communication between the internal electrical path 156 and the intermediate electrical path 154.

In some embodiments, the internal electrical path 156 may be connected to the intermediate electrical path 154 or housing contact pads 148 through one or more intermediary connectors. For instance, a housing cap 158 may be selectively disposed on the filtration housing 112 (e.g., to close the first housing end 116 or second housing end 118). Fixed to the housing cap 158 may be one or more cap contact pads 160 in electrical communication with the internal electrical path 156. When assembled, the cap contact pads 160 may thus be in electrical communication between the internal electrical path 156 and the intermediate electrical path 154.

In certain embodiments, the cap contact pads 160 circumferentially align with and conductively contact the housing contact pads 148. For instance, the cap contact pads 160 may be embedded from an exterior surface of the housing cap 158 at a circumferential rim 162 thereof while one or more mated conductor bodies 164 extend inward through the circumferential rim 162 to the interior of the filtration housing 112. In some such embodiments, the cap contact pads 160 are overmolded within the housing cap 158. The housing label 140 may cover at least a portion of the circumferential rim 162 such that the housing contact pads 148 sit over or radially outward from the cap contact pads 160 (e.g., at the same circumferential location about the filtration housing 112). In turn, an intermediate electrical connection may be formed between the contact pads 148, 160 to permit electrical communication between the two paths 154, 156.

As noted above, the conductor bodies 164 may extend from the cap contact pads 160. In optional embodiments, each conductor body 164 includes a conductive trunk 166 that extends from the cap contact pad 160 and a plurality of conductive branches 168 held within the filtration housing 112. Thus, a discrete conductor body 164 or conductive trunk 166 may extend from each discrete cap contact pad 160. As shown, each of the conductive branches 168 may be circumferentially spaced apart from each other within filtration housing 112. Optionally, the discrete branches 168 of one conductive trunk 166 may be circumferentially interposed between the discrete branches 168 of another conductive trunk 166 such that two or more branches 168 of one conductive trunk 166 are circumferentially interrupted or separated by the branch 168 of another conductive trunk 166. Additionally or alternatively, a radial collar within filtration housing 112 may radially separate the conductive branches 168 of two or more conductive trunks 166 (e.g., such that the radial collar surface acts as a radially barrier between the two sets of branches 168). Thus, one set of conductive branches 168 may be arranged radially inward of another set of conductive branches 168.

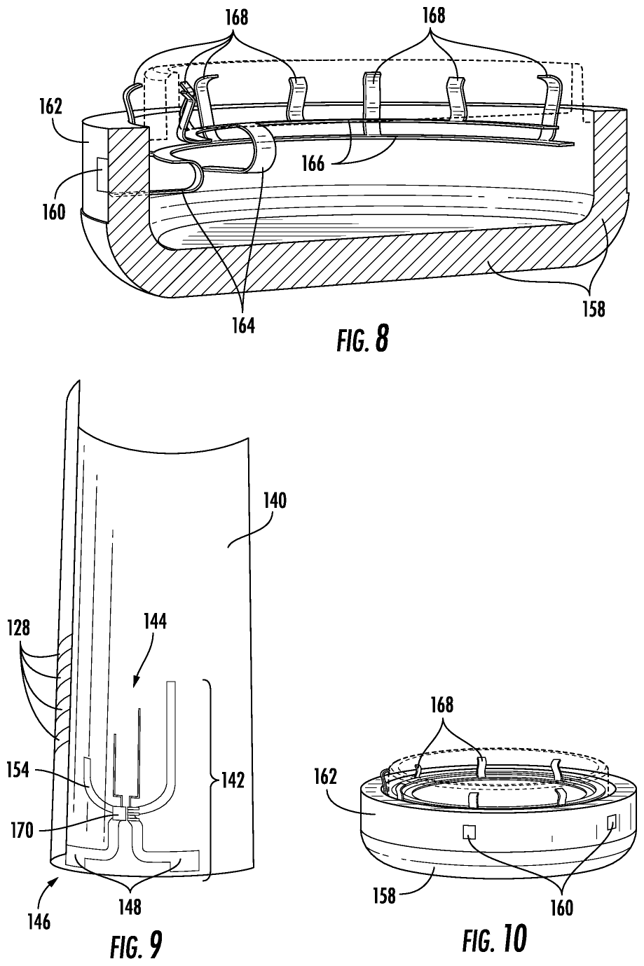

Turning now especially to FIGS. 9 and 12, a validating electrical circuit or electrical chip 170 may be disposed along the intermediate electrical path (e.g., on the housing label 140). Specifically, between the first connector end 144 and the second connector end 146, the electrical chip 170 may be positioned to interrupt electrical communication or the conductive lines in general. Included on the electrical chip 170 may be one or more electrical components, circuits, or processors (e.g., configured to selectively restrict/permit power or communication signals through the electrical chip 170, as would be understood in light of the present disclosure). In some embodiments, the electrical chip 170 is configured to evaluate one or more electrical signals from the first electrical contact 128 and selectively permit power transfer through the electrical chip 170 to the filtration housing 112 based on the evaluation. For instance, the electrical chip 170 may include a Field-Effect Transistor (FET) circuit configured to selectively permit or restrict electrons through the electrical chip 170. Additionally or alternatively, the electrical chip 170 may include a chip processor or controller configured to receive an authentication communication signal from the controller 34 and match the authentication communication signal to a stored condition. In response to matching the authentication communication signal, the chip processor or controller may permit power or communication signals through the electrical chip 170 (e.g., to the internal electrical path 156). Alternately, if the chip processor or controller of chip 170 fails to match the authentication communication signal, the chip processor or controller may be configured to restrict or prevent power or communication signals through the electrical chip 170 (e.g., to the internal electrical path 156).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water filtration assembly comprising:
a filtration housing;
a fluid inlet port and a fluid outlet port fixed to the filtration housing;
a first electrical contact positioned on the filtration housing separate and spaced apart from the fluid inlet port and the fluid outlet port;
a housing label disposed on the filtration housing apart from the fluid inlet port and the fluid outlet port; and
an electrical connector joined to the housing label, the electrical connector defining an intermediate electrical path extending from the first electrical contact to conduct power or communication signals between the water filtration assembly and a separate appliance.

2. The water filtration assembly of claim 1, wherein the first electrical contact comprises a conductive ring extending about the filtration housing.

3. The water filtration assembly of claim 2, wherein the first electrical contact comprises a plurality of parallel conductive rings axially spaced apart along the filtration housing.

4. The water filtration assembly of claim 3, further comprising:
a second electrical contact apart from the filtration housing, the second electrical contact comprising a spring-loaded pin in selective contact with the electrical connector apart from the first electrical contact.

5. The water filtration assembly of claim 1, wherein the electrical connector comprises a rigid card plug extending from the housing label and away from the filtration housing to be received within a contact socket on the separate appliance.

6. The water filtration assembly of claim 1, further comprising:
an internal electrical path disposed within the filtration housing in electrical communication with the intermediate electrical path.

7. The water filtration assembly of claim 6, further comprising a housing contact pad fixed to an external surface of the filtration housing in electrical communication between the internal electrical path and the intermediate electrical path.

8. The water filtration assembly of claim 6, further comprising a housing cap selectively disposed on the filtration housing; and
a cap contact pad fixed to the housing cap in electrical communication between the internal electrical path and the intermediate electrical path.

9. The water filtration assembly of claim 1, further comprising a validating electrical circuit or electrical chip disposed on the housing label along the intermediate electrical path.

10. The water filtration assembly of claim 9, wherein the validating electrical circuit or electrical chip is configured to evaluate one or more electrical signals from the first electrical contact and selectively permit power transfer through the validating electrical circuit or electrical chip to the filtration housing based on the evaluation.

11. A refrigerator appliance comprising:
a cabinet defining a chilled chamber;
a water filter selectively mounted to the cabinet, the water filter comprising
a filtration housing,
a fluid inlet port and a fluid outlet port fixed to the filtration housing,
a first electrical contact positioned on the filtration housing separate and spaced apart from the fluid inlet port and the fluid outlet port,
a housing label disposed on the filtration housing apart from the fluid inlet port, and
an electrical connector joined to the housing label, the electrical connector defining an intermediate electrical path extending from the first electrical contact to conduct power or communication signals between the water filter and the cabinet; and
a second electrical contact fixed to the cabinet and spaced apart from the filtration housing in selective electrical communication with the first electrical contact.

12. The refrigerator appliance of claim 11, wherein the first electrical contact comprises a conductive ring extending about the filtration housing.

13. The refrigerator appliance of claim 12, wherein the first electrical contact comprises a plurality of parallel conductive rings axially spaced apart along the filtration housing.

14. The refrigerator appliance of claim 12, the second electrical contact comprising a spring-loaded pin in selective contact with the electrical connector apart from the first electrical contact.

15. The refrigerator appliance of claim 11, wherein the electrical connector comprises a rigid card plug extending from the housing label and away from the filtration housing to be received within a contact socket on the refrigerator appliance.

16. The refrigerator appliance of claim 11, further comprising:
an internal electrical path disposed within the filtration housing in electrical communication with the intermediate electrical path.

17. The refrigerator appliance of claim 16, further comprising a housing contact pad fixed to an external surface of the filtration housing in electrical communication between the internal electrical path and the intermediate electrical path.

18. The refrigerator appliance of claim 16, further comprising a housing cap selectively disposed on the filtration housing; and
a cap contact pad fixed to the housing cap in electrical communication between the internal electrical path and the intermediate electrical path.

19. The refrigerator appliance of claim 11, further comprising a validating electrical circuit or electrical chip disposed on the housing label along the intermediate electrical path.

20. The refrigerator appliance of claim 19, wherein the validating electrical circuit or electrical chip is configured to evaluate one or more electrical signals from the first electrical contact and selectively permit power transfer through the validating electrical circuit or electrical chip to the filtration housing based on the evaluation.
